(19) United States
(12) Patent Application Publication
(10) Pub. No.: US 2015/0211279 A1
(43) Pub. Date: Jul. 30, 2015

(54) ROTATION AND STOP RETENTION SWITCHING APPARATUS

(71) Applicant: Aisin Seiki Kabushiki Kaisha, Kariya-shi (JP)

(72) Inventors: Ryusei SUZUKI, Chiryu-shi (JP); Yasuo IMATOMI, Northville, MI (US); Toshiyuki SAKAI, Kariya-shi (JP); Takeshi YAMAMOTO, Takahama-shi (JP)

(73) Assignee: Aisin Seiki Kabushiki Kaisha, Kariya-shi (JP)

(21) Appl. No.: 14/594,385

(22) Filed: Jan. 12, 2015

(30) Foreign Application Priority Data
Jan. 29, 2014 (JP) 2014-014818

(51) Int. Cl. E05F 3/22; E05F 5/02; E05F 3/16

(52) U.S. Cl. CPC E05F 3/22; E05F 3/16; E05F 5/025

(57) ABSTRACT

A rotation and stop retention switching apparatus includes a shaft portion within which an output shaft of a drive motor is configured to be disposed, a pivot member placed at a circumference of the shaft portion, a rotary body placed opposite the body in an axial direction, a pivot shaft pivotally supporting the pivot member, a biasing member disposed at the pivot member to be supported thereby, and a switching member pressing the pivot member to separate the pivot member from the shaft portion against a biasing force applied by the biasing member in accordance with a rotation of the output shaft. The rotary body rotates by a rotation force applied by the output shaft by a gap formed between the pivot member and the shaft portion in a case where the pivot member is pressed by the switching member in accordance with the rotation of the output shaft.

### CROSS REFERENCE TO RELATED APPLICATIONS

This application is based on and claims priority under 35 U.S.C. §119 to Japanese Patent Application 2014-014818, filed on Jan. 29, 2014, the entire content of which is incorporated herein by reference.

### TECHNICAL FIELD

This disclosure generally relates to a rotation and stop retention switching apparatus.

### BACKGROUND DISCUSSION

A door opening and closing device for a vehicle which allows to open and close a vehicle door manually and automatically by transmitting human power or rotary power of a drive motor by a spindle and which allows to hold the vehicle door in a stopped state desirably regardless of a degree of opening of the vehicle door has been developed.

A known door opening and closing device employs a freely-stoppable method which can stop a door desirably regardless of a degree of opening of the door by stopping and holding the door in a stopped state by, for example, cogging torque of a drive motor, resistance force of a gear and holding power of a screw.

According to a rotation and stop retention switching apparatus disclosed in DE202007015597U (hereinafter referred to as Patent reference 1), a rotary member rotates, stops and holds in a stopped state by resistance force generated by frictional engagement between a torsion coil spring and a member. By mounting the rotation and stop retention switching apparatus to a door opening and closing device, a door can be manually and automatically opened, closed, or held in the stopped state.

According to the aforementioned known door opening and closing device, a heavy door cannot be stopped and held in the stopped state because of insufficient holding force applied by the cogging torque of the drive motor and the resistance force of the gear. The screw is required to increase holding force in order to increase stopping and holding force of the door. To increase holding force, a lead length of the screw should be shortened, however, in those circumstances, the opening and closing speed of the door decreases.

According to the rotation and stop retention switching apparatus as disclosed in Patent reference 1, it is difficult to release the friction engagement over the engagement portion in order to rotate the rotary body, and the resistance force generated by the friction engagement still exists partially. Thus, the outputted rotary force decreases and a drive motor is required to be upsized if used.

A need thus exists for a rotation and stop retention switching apparatus which is not susceptible to the drawback mentioned above.

### SUMMARY

According to an aspect of this disclosure, a rotation and stop retention switching apparatus includes a body including a shaft portion within which an output shaft of a drive motor is configured to be disposed by insertion, the body configured to be connected to the drive motor, a pivot member being placed at a circumference of the shaft portion so as to surround the shaft portion, a rotary body being placed opposite the body in an axial direction, a pivot shaft including a first end supported by the rotary body, the pivot shaft pivotally supporting the pivot member, a biasing member being disposed at the pivot member which is placed at the circumference of the shaft portion, the biasing member being supported by the pivot member, and a switching member configured to be connected to the output shaft, the switching member pressing the pivot member in a direction to separate the pivot member from the shaft portion against a biasing force applied by the biasing member in accordance with a rotation of the output shaft. The pivot shaft pivotally supports the pivot member at an opposite side of the biasing member relative to the shaft portion so as to interpose the shaft portion between the pivot member and the biasing member. The pivot member comes close to and comes in contact with the shaft portion by the biasing force applied by the biasing member. The rotary body rotates by a rotation force applied by the output shaft by a gap formed between the pivot member and the shaft portion in a case where the pivot member is pressed by the switching member in accordance with the rotation of the output shaft.

According to another aspect of this disclosure, a spindle includes a rotation and stop retention switching apparatus including a body including a shaft portion within which an output shaft of a drive motor is configured to be disposed by insertion, the body configured to be connected to the drive motor, a pivot member being placed at a circumference of the shaft portion so as to surround the shaft portion, a rotary body being placed opposite the body in an axial direction, a pivot shaft including a first end supported by the rotary body, the pivot shaft pivotally supporting the pivot member, a biasing member being disposed at the pivot member which is placed at the circumference of the shaft portion, the biasing member being supported by the pivot member, and a switching member configured to be connected to the output shaft, the switching member pressing the pivot member in a direction to separate the pivot member from the shaft portion against a biasing force applied by the biasing member in accordance with a rotation of the output shaft. The pivot shaft pivotally supports the pivot member at an opposite side of the biasing member relative to the shaft portion so as to interpose the shaft portion between the pivot member and the biasing member. The pivot member comes close to and comes in contact with the shaft portion by the biasing force applied by the biasing member. The rotary body rotates by a rotation force applied by the output shaft by a gap formed between the pivot member and the shaft portion in a case where the pivot member is pressed by the switching member in accordance with the rotation of the output shaft. The spindle further includes a drive motor, a planetary gear, and a screw. The drive motor, the rotation and stop retention switching apparatus, the planetary gear and the screw are connected in the mentioned order.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a longitudinal sectional view of a switching apparatus mounted to a door opening and closing device according to an embodiment disclosed here;

FIG. 2 is a longitudinal sectional view of the switching apparatus according to the embodiment;

FIG. 3A is a perspective view of the switching apparatus according to the embodiment;

FIG. 3B is a perspective view of the switching apparatus when viewed from a different direction from FIG. 3A according to the embodiment;

FIG. 4A is a perspective view of a first pivot member which is mounted to the switching apparatus according to the embodiment;

FIG. 4B is a perspective view of a combined body of the first pivot member and a second pivot member according to the embodiment;

FIG. 5A is a perspective view of the switching apparatus based on a cross section taken along line V-V and viewed from an arrow C of FIG. 2 according to the embodiment.

FIG. 5B is a perspective view of the switching apparatus in which a cam member is removed from FIG. 5A according to the embodiment;

FIG. 6A is a cross sectional view taken along line VI-VI when viewed from an arrow A of FIG. 2 illustrating the switching apparatus which is in a stopped state according to the embodiment;

FIG. 6B is a cross sectional view taken along line VI-VI when viewed from an arrow B of FIG. 2 illustrating the switching apparatus which is in the stopped state according to the embodiment;

FIG. 7A is a cross sectional view taken along line VII-VII when viewed from the arrow A of FIG. 2 illustrating the switching apparatus which is in an automatic rotation state according to the embodiment;

FIG. 7B is a cross sectional view taken along line VII-VII when viewed from the arrow B of FIG. 2 illustrating the switching apparatus which is in the automatic rotation state according to the embodiment;

FIG. 8A is a cross sectional view taken along line VIII-VIII when viewed from the arrow A of FIG. 2 illustrating the switching apparatus which is in a manual rotation state according to the embodiment; and

FIG. 8B is a cross sectional view taken along line VIII-VIII when viewed from the arrow B of FIG. 2 illustrating the switching apparatus which is in the manual rotation state according to the embodiment.

### DETAILED DESCRIPTION

A rotation and stop retention switching apparatus according to an embodiment will be explained with reference to the drawings. Hereinafter, the rotation and stop retention switching apparatus is referred to as a switching apparatus. The drawings may be depicted in different scales to facilitate an easy understanding.

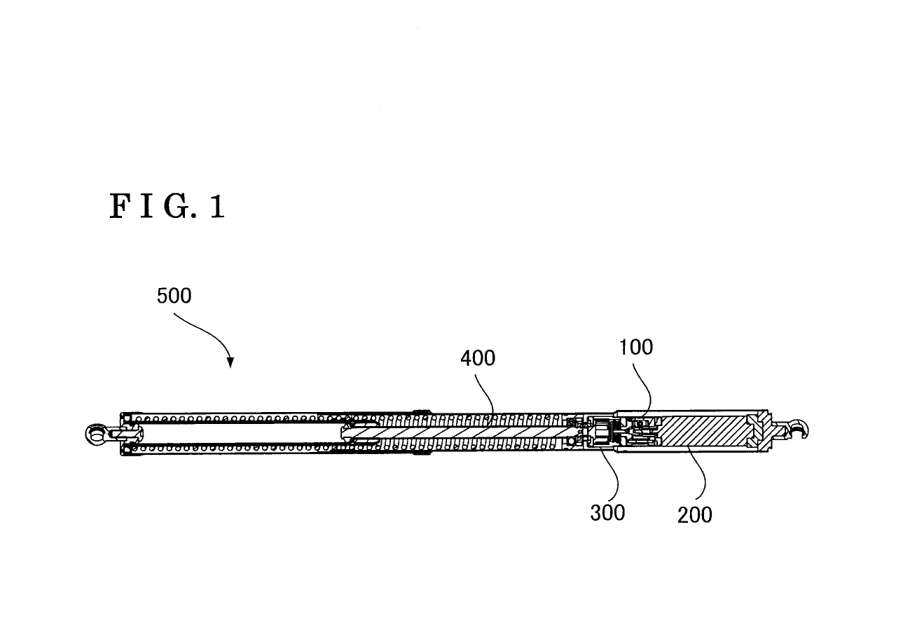

As shown in FIG. 1, a door opening and closing device 500 includes both end portions which are mounted to a tailgate of a vehicle and a vehicle body, respectively, similarly to a known door opening and closing device. A drive motor 200 rotates and transmits rotary power to a screw 400 via a switching apparatus 100 and a planetary gear (a gear) 300. When the screw 400 rotates, the door opening and closing device 500 extends and contracts in a longitudinal direction to open and close the tailgate of the vehicle.

According to the embodiment, the door opening and closing device 500 includes the switching apparatus 100, which corresponds to a feature of this disclosure.

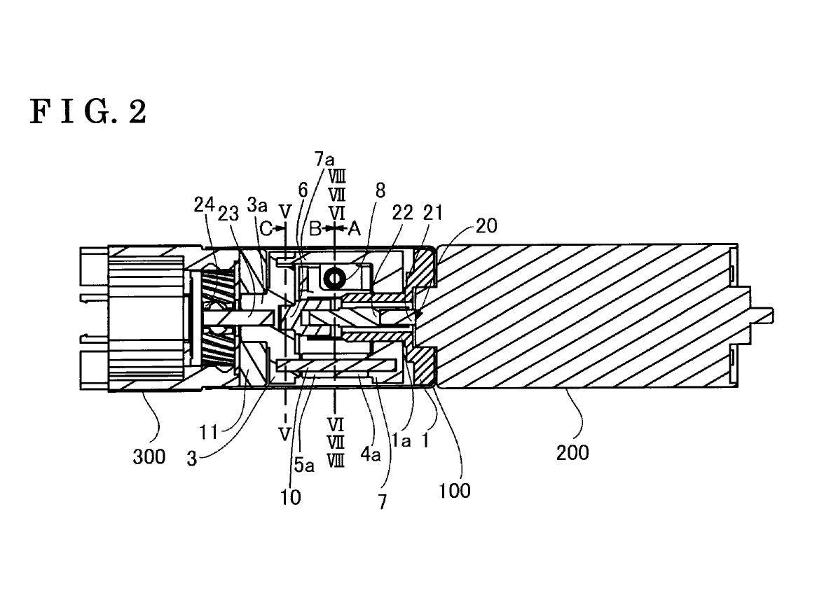

Next, the construction of the switching apparatus 100 will be explained with reference to FIGS. 2 to 5.

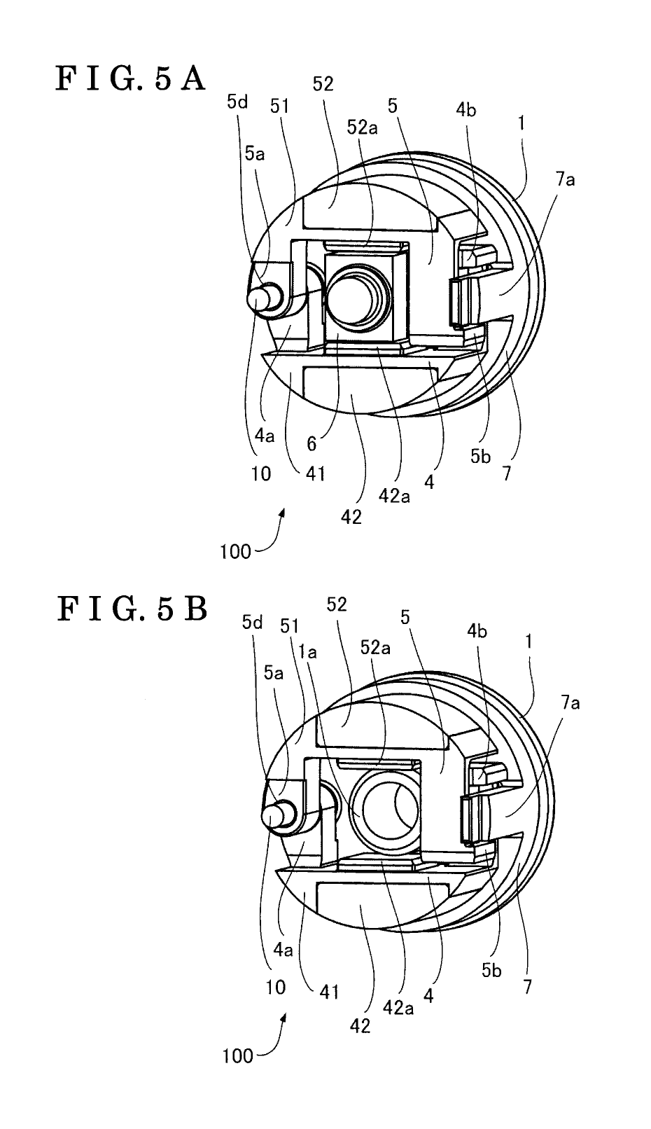

In FIG. 2, the switching apparatus 100 is shown with the drive motor 200 and the planetary gear 300 which are connected to the switching apparatus 100. In each of FIGS. 5A and 5B, a rotary body 3 is not depicted.

As shown in FIG. 2, a first output shaft 21 of the drive motor 200 is positioned to be held by a hollow cylindrical-shaped shaft portion 1a which is provided at a body 1 of the switching apparatus 100. The switching apparatus 100 is connected to the drive motor 200. According to the embodiment, a first connection shaft 22 is connected to the first output shaft 21 of the drive motor 200 to integrally rotate with each other, and the first connection shaft 22 and the first output shaft 21 are collectively referred to as a second output shaft 20. The drive motor 200 is attached to the body 1 of the switching apparatus 100. A body of the drive motor 200 and the shaft portion 1a attached to the drive motor 200 do not rotate whereas the second output shaft 20 rotates in response to a drive power applied by the drive motor 200.

An end of the first connection shaft 22 is fitted and fixed into a hole portion of a cam member 6 (i.e., serving as a switching member) which is formed in a quadrilateral in a front view and extends and contracts in an axial direction. The cam member 6 is fitted into and supported by a hole portion which is formed at a center portion of the rotary body 3 (clutch holder) so that the cam member 6 and the rotary body 3 are relatively rotatable. The rotary body 3 includes a shaft portion 3a which is placed opposite the hole portion in which the cam member 6 is fitted and supported. A second connection shaft 23 is fitted and fixed into a hole portion of the shaft portion 3a. The second connection shaft 23 is fixed with a gear 24 which meshes with a gear portion of the planetary gear 300. Alternatively, a cam member may be inserted by the first connection shaft 22 which is fitted into and supported by the hole portion of the rotary body 3.

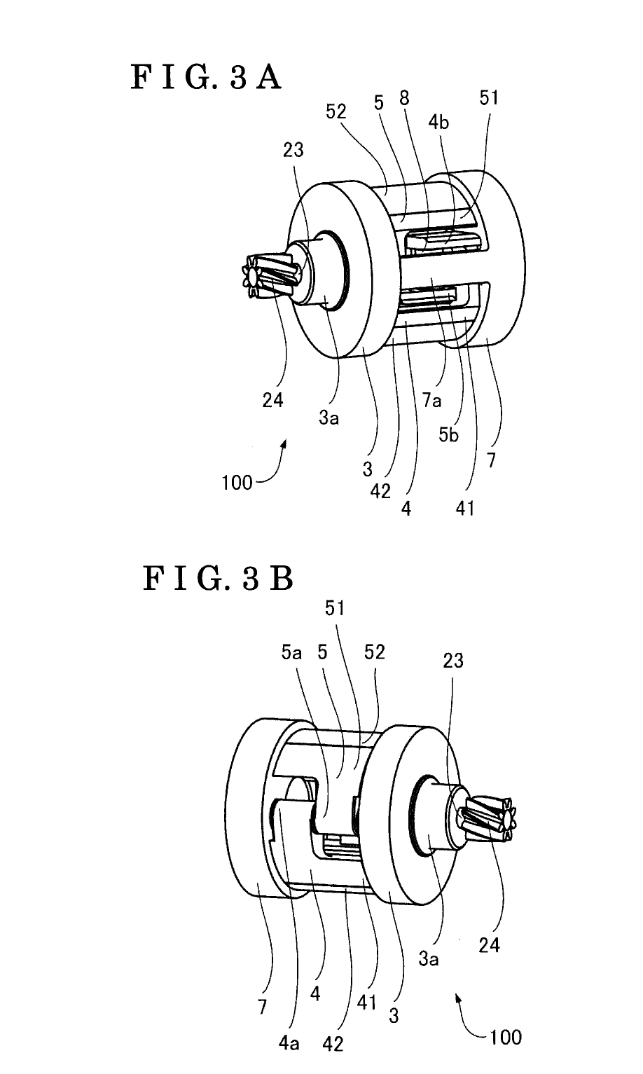

As shown in FIGS. 2, 3A and 3B, a secondary rotary body 7 (clutch cover) is provided at a circumference of the shaft portion 1a of the body 1 of the switching apparatus 100 so as to surround or retain(or hold) the shaft portion 1a. A pair of a first pivot member 4 and a second pivot member 5 which are formed in the same shape is interposed between the rotary body 3 and the secondary rotary body 7. A protruding portion 7a of the secondary rotary body 7 extends in the axial direction at an outside of the first and second pivot members 4, 5 and an end of the protruding portion 7a is fixed to the rotary body 3.

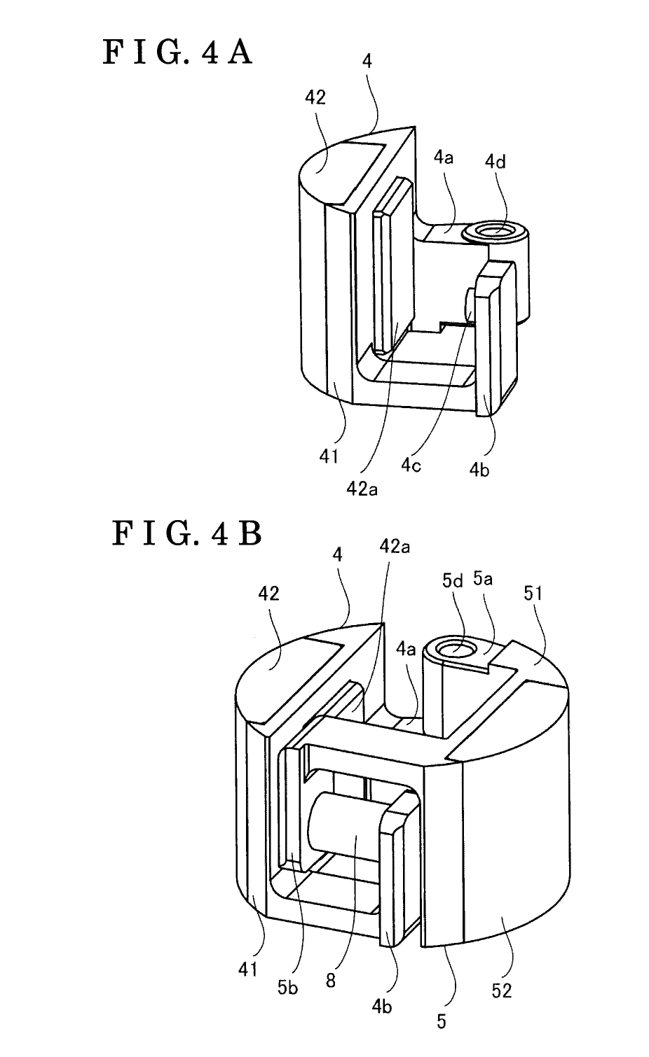

The first and second pivot members 4, 5 is pivotally combined with each other at the circumference of the shaft portion 1a of the body 1 of the switching apparatus 100 so as to surround the shaft portion 1a. Specifically, as shown in FIG. 3B, first and second pivot hole forming portions 4a, 5a are provided at end portions of the first and second pivot members 4, 5, respectively, at the circumference of the shaft portion 1a. The first and second pivot hole forming portions 4a, 5a are provided with respective first and second through holes (pivot holes) 4d, 5d (see FIGS. 4A and 4B) which surround or retain (or hold) a stick member 10 (i.e., serving as a pivot shaft).

The first and second pivot hole forming portions 4a, 5a are positioned opposite the protrusion portion 7a of the secondary rotary body 7 so that the first and second pivot hole forming portions 4a, 5a and the protrusion portion 7a sandwich the second output shaft 20 between the first and second pivot hole forming portions 4a, 5a and the protrusion portion 7a. The stick member 10 is positioned to be surrounded or held by the first and second through holes 4d, 5d and is supported by the rotary body 3 and the secondary rotary body 7. The first and second pivot hole forming portions 4a, 5a of the first and second pivot members 4, 5 are positioned in series with each other and the first and second pivot members 4, 5 are pivotally supported by the stick member 10.

As above, according to the embodiment, the first and second pivot members 4, 5 employ an opposite-end supported construction in which the first and second pivot members 4, 5 are interposed between the rotary body 3 and the secondary rotary body 7, and opposing ends of the stick member 10 which is surrounded or held by the first and second through holes (pivot holes) 4d, 5d are supported by the rotary body 3 and the secondary rotary body 7, respectively. Alternatively, the first and second pivot members 4, 5 can employ one-end supported construction in which the first and second pivot members 4, 5 (or the stick member 10) are supported only by the rotary body 3 without including the secondary rotary body 7 as long as sufficient rigidity is maintained.

As described above, the first and second pivot members 4, 5 are pivotally supported by the stick member 10 which is supported by the rotary body 3 and the secondary rotary body 7, and are displaced in directions toward and away from the shaft portion 1a in accordance with the pivoting movement of the first and second pivot members 4, 5.

As shown in FIGS. 4A and 4B, the first pivot member 4 is configured with a first clutch lever 41 and a first anchor portion 42. Similarly, the second pivot member 5 is configured with a second clutch lever 51 and an anchor portion 52. The first anchor portion 42 is positioned at a side which is away from the shaft portion 1a of the body 1 relative to the first clutch lever 41. Similarly, the anchor portion 52 is positioned at a side which is away from the shaft portion 1a of the body 1 relative to the second clutch lever 51. Because the first and second pivot members 4, 5 are formed in the same shape, hereinafter, the construction of the first and second pivot members 4, 5 will be described using the first pivot member 4 with the reference numerals of the second pivot member 5 which are within brackets. The first clutch lever 41 (the second clutch lever 51) includes a first protruding portion 42a (a second protruding portion 52a) protruding from a surface of the first clutch lever 41 (the second clutch lever 51) toward the shaft portion 1a. The first clutch lever 41 (the second clutch lever 51) includes the first pivot hole forming portion 4a (the second pivot hole forming portion 5a) which is provided with the first through hole 4d (the second through hole 5d) and a first spring seat 4b (a second spring seat 5b) which is formed in an L-shaped cantilever construction (also referred to as the first cantilevered spring seat 4b and the second cantilevered spring seat 5b). The first pivot hole forming portion 4a (the second pivot hole forming portion 5a) and the first spring seat 4b (the second spring seat 5b) are constructed to face with each other and sandwich the shaft portion 1a of the body 1 therebetween. The first spring seat 4b (the second spring seat 5b) is provided with a first projection 4c (a second projection 5c) which guides a coil spring 8 (serving as a biasing member). The first projection 4c (the second projection 5c) serves as a prevention which inhibits the first clutch lever 41 (the second clutch lever 51) from pivotally moving by a predetermined pivot angle or greater caused by centrifugal force. According to the embodiment, the first clutch lever 41 (the second clutch lever 51) and the first anchor portion 42 (the second anchor portion 52) are formed individually and combined with each other. Alternatively, the first clutch lever 41 (the second clutch lever 51) and the first anchor portion 42 (the second anchor portion 52) are formed integrally as a single member.

As shown in FIGS. 4A and 4B, the first and second pivot members 4, 5 are disposed to be symmetric with 180 degree rotation around an axis. The first and second pivot members 4, 5 are disposed orthogonal to the second output shaft 20. In addition, the first and second pivot members 4, 5 are disposed along a direction where the first pivot hole forming portion 4a (the second pivot hole forming portion 5a) and the first spring seat 4b (the second spring seat 5b) face with each other to sandwich the shaft portion 1a of the body 1 between the first pivot hole forming portion 4a (the second pivot hole forming portion 5a) and the first spring seat 4b (the second spring seat 5b). By rotationally symmetrically combining the first and second spring seats 4b, 5b each of which includes the L-shaped cantilever construction, the first spring seat 4b of the first pivot member 4 is placed between the spring seat 5b and the second clutch lever 51 of the second pivot member 5 while the spring seat 5b of the second pivot member 5 is placed between the first spring seat 4b and the first clutch lever 41 of the first pivot member 4. The coil spring 8 is placed between the first and second spring seats 4b, 5b, and biases the first and second spring seats 4b, 5b so as to be away from each other. When the first and second spring seats 4b, 5b are biased to be away from each other, the first and second protruding portions 42a, 52a of the first and second pivot members 4, 5 are displaced in a direction to come close to each other. Accordingly, the first and second protruding portions 42a, 52a of the first and second pivot members 4, 5 come in contact with and come to frictionally engage with the shaft portion 1a.

As shown in FIG. 5A, the cam member 6 comes in contact with or comes to be away from the first and second protruding portions 42a, 52a. As shown in FIG. 5B, the shaft portion 1a of the body 1 comes in contact with or comes to be away from the first and second protruding portions 42a, 52a in accordance with the pivoting movement of the first and second pivot members 4, 5.

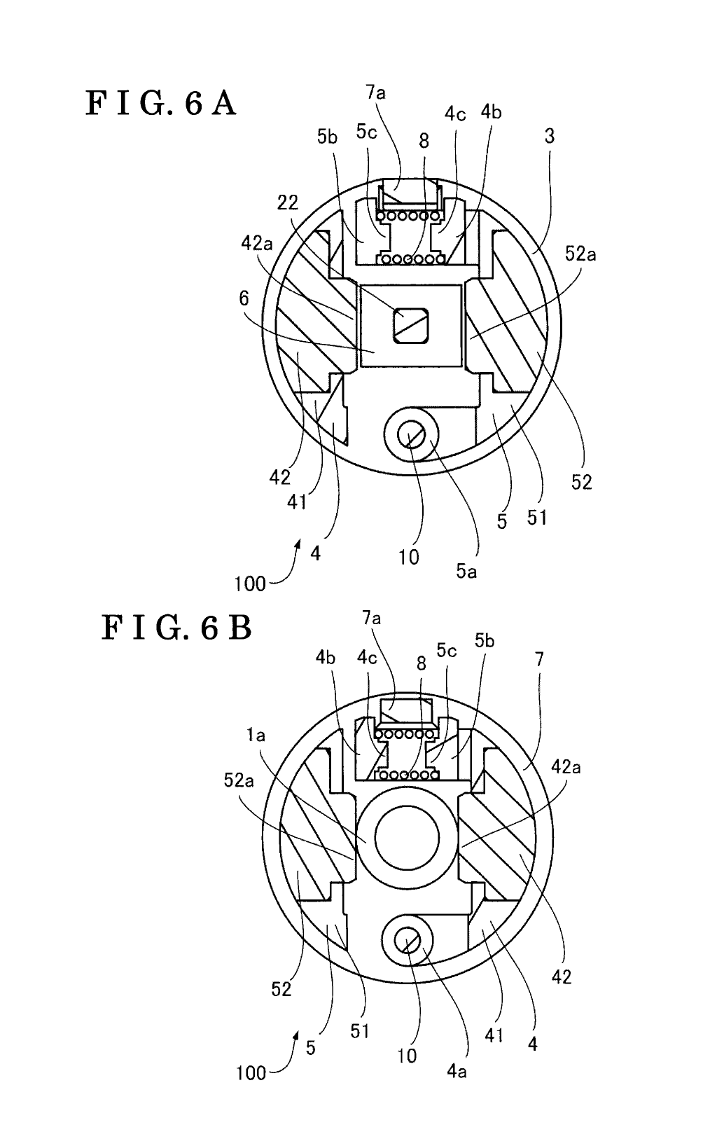

Next, the operation of the switching apparatus 100 will be explained with reference to FIGS. 6A, 6B, 7A, 7B, 8A and 8B. The first connection shaft 22 is not depicted in each of FIGS. 6A, 6B, 7A, 7B, 8A and 8B.

When the drive motor 200 is not rotary driven, that is, when the drive motor 200 is in a stopped state, as shown in FIG. 6B, the first and second protruding portions 42a, 52a of the first and second pivot members 4, 5 press-fit the shaft portion 1a of the body 1 by biasing force applied by the coil spring 8. Accordingly, the stopped state of the first and second pivot members 4, 5 and the rotary body 3 is maintained by the frictional engagement between the first and second protruding portions 42a, 52a of the first and second pivot members 4, 5 and the shaft portion 1a of the body 1. Thus, a screw 400 is held in a stopped state.

Thus, when the door opening and closing device 500 which is provided with the switching apparatus 100 of the embodiment is mounted to the tailgate of the vehicle, the screw 400 is maintained in the stopped state when the drive motor 200 is not rotary driven. Accordingly, the door can be held in the stopped state desirably regardless of the weight and degree of opening of the door.

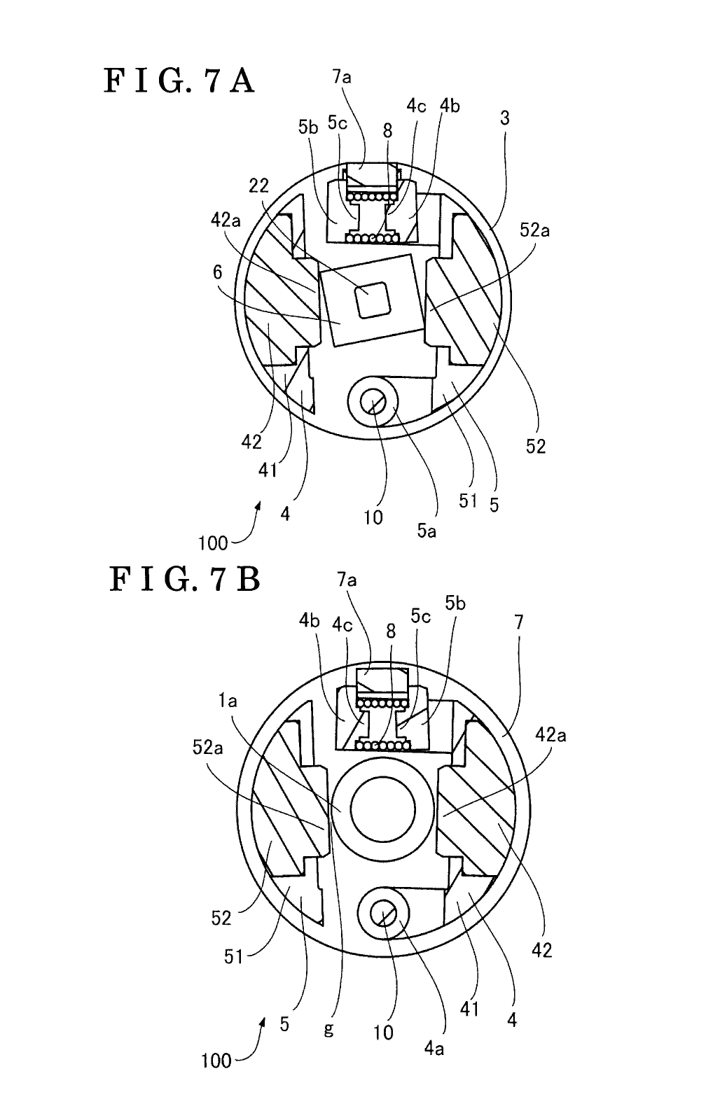

Next, when the drive motor 200 is driven, as shown in FIGS. 7A and 7B, the second output shaft 20, that is, the first connection shaft 22 is automatically rotated. Accordingly, the first and second pivot members 4, 5 are displaced in a direction away from the shaft portion 1a because the cam member 6 comes in contact with the first and second protruding portions 42a, 52a of the first and second pivot members 4, 5 in a rotationally displaced state. Thus, the first and second clutch levers 41, 51 pivot in a direction away from the shaft portion 1a against biasing force of the coil spring 8, and a gap g is formed between each of the first and second protruding portions 42a, 52a and the shaft portion 1a. As a result, the frictional engagement between the shaft portion 1a and each of the first and second protruding portions 42a, 52a is released so that the shaft portion 1a and the first and second protruding portions 42a, 52a cannot retain or hold the rotary body 3 in a stopped state. Accordingly, the cam member 6, the first and second pivot members 4, 5 and the rotary body 3 integrally rotate with each other.

Thus, when the door opening and closing device 500 which is provided with the switching apparatus 100 of the embodiment is mounted to the tailgate of the vehicle, the screw 400 rotates in accordance with the rotation of the drive motor 200. Accordingly, the door opening and closing device 500 extends or contracts to open and close the door.

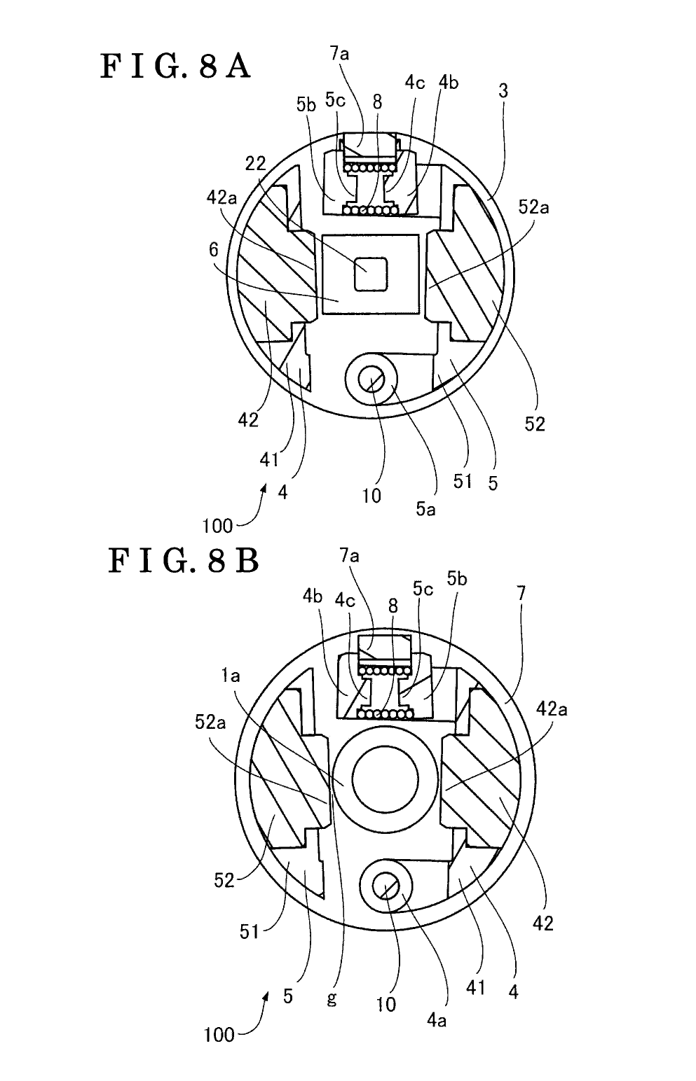

When the rotary body 3 is manually rotated, the first and second pivot members 4, 5 rotate in accordance with the rotation of the rotary body 3. Thus, centrifugal force is applied to the first and second anchor portions 42, 52 of the first and second pivot members 4, 5. The first and second pivot members 4, 5 come to be away from the shaft portion 1a by centrifugal force applied to the first and second anchor portions 42, 52 of the first and second pivot members 4, 5. As shown in FIGS. 8A and 8B, the first and second clutch levers 41, 51 pivot in a direction away from the shaft portion 1a against biasing force of the coil spring 8 and the gap g is formed between each of the first and second protruding portions 42a, 52a and the shaft portion 1a. As a result, the frictional engagement between the shaft portion 1a and each of the first and second protruding portions 42a, 52a is released so that the rotary body 3 and the first and second pivot members 4, 5 can rotate smoothly.

Accordingly, when an operator tries to open and close the door manually in a state where the door opening and closing device 500 which is provided with the switching apparatus 100 of the embodiment is mounted to the tailgate of the vehicle, the rotary body 3 rotates in accordance with the rotation of the screw 400. Thus, the switching apparatus 100 is switched to be in a rotary state to open and close the door manually without an application of the force excessively.

Thus, as described above, when the door opening and closing device 500 which is provided with the switching apparatus 100 of the embodiment is mounted to the tailgate of the vehicle, the door can be stopped desirably regardless of the weight and degree of opening of the door. That is, a heavy door can be stopped desirably. At the same time, the door can be opened and closed manually.

When starting the manual operation of the door, an operator is required to have operating force which exceeds stopping and retaining force (or holding force) resulting from the frictional engagement of the shaft portion 1a of the body 1 and each of the first and second protruding portions 42a, 52a of the first and second pivot members 4, 5. However, once the rotary body 3 rotates, centrifugal force is applied to the first and second anchor portions 42, 52 by the rotation of the rotary body 3 and the gap g is formed between each of the first and second pivot members 4, 5 and the shaft portion 1a. Accordingly, the rotary body 3 can be rotated easily and an operator can easily open and close the door manually using the small operation force.

According to the embodiment, as shown in FIG. 1, the drive motor 200, the switching apparatus 100, the gear (the planetary gear) 300, and the screw 400 are connected in the mentioned order to construct the door opening and closing device 500. Being positioned between the switching apparatus 100 and the screw 400, the gear 300 increases the rotary speed of the switching apparatus 100. Accordingly, the first and second anchor portions 42, 52 for generating centrifugal force can be minimized, leading to the downsizing of the switching apparatus 100 per se.

Further, when the screw 400 and the rotary body 3 of the switching apparatus 100 are rotated to open and close the door manually, an operator can decrease the manual operating force immediately after starting the rotation because an inputted manual operation force increases in speed via the gear 300 to achieve high speed rotation.

According to the switching apparatus 100 of the embodiment, because the first and second clutch levers 41, 51 are manufactured in the same shape, the switching apparatus 100 can be produced with a simple configuration by reducing the number of members, which leads to the contribution of the cost reduction. Further, a spring seat for supporting the coil spring 8 to the secondary rotary body 7 and stoppers for inhibiting the first and second clutch levers 41, 51 from pivotally moving excessively by centrifugal force are not required.

According to the embodiment, the first clutch lever 41 (the second clutch lever 51) is not provided with a known electromagnetic clutch, and thus, an electric control for the electromagnetic clutch is not required. The frictional engagement of each of the first and second clutch levers 41, 51 and the shaft portion 1a of the body 1 is released automatically in accordance with the rotation of the rotary body 3 by the small-sized drive motor 200 or the manual operation to open and close the tailgate. When the rotation of the rotary body 3 is stopped, the stopped state of the rotary body 3 is securely maintained by the frictional engagement. Accordingly, the tailgate can be held at a desired stopped position by sufficient holding force. Further, contacting surfaces of each of the first and second protruding portions 42a, 52a of the first and second pivot members 4, 5 and an outer circumferential surface of the shaft portion 1a can be formed with narrow ditches or protruding and recessing waviness to apply an activation feeling for the manual operation.

According to the embodiment, the switching apparatus 100 is mounted to the door opening and closing device 500. Alternatively, the switching apparatus 100 can be used for opening and closing a sliding door or a window of the vehicle, or for raising and lowering of the seat of the vehicle.

According to the embodiment, the first and second pivot members 4, 5 serve as a pair. Alternatively, a single pivot member is applicable in a case where the drive motor 200 or manual operation perform low speed operation.

According to the aforementioned embodiment, the rotation and stop retention switching apparatus 100 includes the body 1 including the shaft portion 1a within which the second output shaft 20 of the drive motor 200 is configured to be disposed by insertion, the body 1 configured to be connected to the drive motor 200, the pivot member (the first and second pivot members 4, 5) being placed at the circumference of the shaft portion 1a so as to surround the shaft portion 1a, the rotary body 3 being placed opposite the body 1 in the axial direction, the pivot shaft 10 including the first end supported by the rotary body 3, the pivot shaft 10 pivotally supporting the pivot member (4, 5), the biasing member (the coil spring 8) being disposed at the pivot member (the first and second pivot members 4, 5) which is placed at the circumference of the shaft portion 1a, the biasing member (the coil spring 8) being supported by the pivot member (the first and second pivot members 4, 5), and the switching member (the cam member 6) configured to be connected to the output shaft 20, the switching member 6 pressing the pivot member (the first and second pivot members 4, 5) in the direction to separate the pivot member (the first and second pivot members 4, 5) from the shaft portion (1a) against biasing force applied by the biasing member (the coil spring 8) in accordance with the rotation of the output shaft 20. The pivot shaft 10 pivotally supports the pivot member (the first and second pivot members 4, 5) at the opposite side of the biasing member (the coil spring 8) relative to the shaft portion 1a so as to interpose the shaft portion 1a between the pivot member (the first and second pivot members 4, 5) and the biasing member (the coil spring 8). The pivot member (the first and second pivot members 4, 5) comes close to and comes in contact with the shaft portion 1a by the biasing force applied by the biasing member (the coil spring 8). The rotary body 3 rotates by rotation force applied by the output shaft 20 by the gap g formed between the pivot member (the first and second pivot members 4, 5) and the shaft portion 1a in a case where the pivot member (the first and second pivot members 4, 5) is pressed by the switching member (the cam member 6) in accordance with the rotation of the output shaft 20.

According to the aforementioned embodiment, when the switching apparatus 100 is mounted to the door opening and closing device 500, the door can be stopped and held in the stopped state by the switching apparatus 100. Thus, the lead length of the screw 400 can increase, leading to the increase of the opening and closing speed of the door.

According to the switching apparatus 100 of the aforementioned embodiment, resistance generated by the contact between the pivot member (the first and second pivot members 4, 5) and the shaft portion 1a can be released completely by the rotation of the rotary body 3. Accordingly, the output of rotary force does not decrease. In a case where the drive motor 200 is used, the drive motor 200 does not have to be upsized.

According to the aforementioned embodiment, the pivot member (the first and second pivot members 4, 5) includes the first pivot member 4 and the second pivot member 5 serving as a pair, the first pivot member 4 and the second pivot member 5 facing with each other at the circumference of the shaft portion 1a. The biasing member 8 is placed between the first pivot member 4 and the second pivot member 5. The biasing member 8 includes the first end supported by the first pivot member 4 while including the second end supported by the second pivot member 5.

The coil spring 8 is placed between the first and second spring seats 4b, 5b, and biases the first and second spring seats 4b, 5b so as to be away from each other. When the first and second spring seats 4b, 5b are biased to be away from each other, the first and second protruding portions 42a, 52a of the first and second pivot members 4, 5 are displaced in a direction to come close to each other. Accordingly, the first and second protruding portions 42a, 52a of the first and second pivot members 4, 5 come in contact with and come to frictionally engage with the shaft portion 1a.

According to the aforementioned embodiment, the switching member 6 includes the cam member 6 and the gap g is formed between the first pivot member 4 and the shaft portion 1a and the gap g is formed between the second pivot member 5 and the shaft portion 1a in a case where the cam member 6 rotates in accordance with the rotation of the output shaft 20 and the cam member 6 presses the first pivot member 4 and the second pivot member 5 to pivotally move the first pivot member 4 and the second pivot member 5 in a direction away from the shaft portion 1a against the biasing force applied by the biasing member (the coil spring 8).

As a result, the frictional engagement between the shaft portion 1a and each of the first and second protruding portions 42a, 52a is released so that the shaft portion 1a and the first and second protruding portions 42a, 52a cannot retain or hold the rotary body 3 in a stopped state. Accordingly, the cam member 6, the first and second pivot members 4, 5 and the rotary body 3 integrally rotate with each other.

According to the aforementioned embodiment, the first pivot member 4 and the second pivot member 5 are rotationally symmetrically placed with each other.

By rotationally symmetrically combining the first and second spring seats 4b, 5b each of which includes the L-shaped cantilever construction, the first spring seat 4b of the first pivot member 4 is placed between the spring seat 5b and the second clutch lever 51 of the second pivot member 5 while the spring seat 5b of the second pivot member 5 is placed between the first spring seat 4b and the first clutch lever 41 of the first pivot member 4.

According to the aforementioned embodiment, each of the first pivot member 4 and the second pivot member 5 includes the clutch lever 41, 51 and the anchor portion 42, 52. The gap g is formed between the first pivot member 4 and the shaft portion 1a and the gap g is formed between the second pivot member 5 and the shaft portion 1a in a case where the first pivot member 4 and the second pivot member 5 rotate in accordance with the rotation of the rotary body 3 to pivotally move in the direction away from the shaft portion 1a in accordance with centrifugal force applied to each of the anchor portions 42, 52 of the first pivot member 4 and the second pivot member 5.

As a result, the frictional engagement between the shaft portion 1a and each of the first and second protruding portions 42a, 52a is released so that the rotary body 3 and the first and second pivot members 4, 5 can rotate smoothly.

According to the aforementioned embodiment, the first pivot member 4 and the second pivot member 5 facing with each other at the circumference of the shaft portion 1a include the end portions, respectively, each of the end portions being provided with the spring seat 4b, 5b having the cantilever construction. The spring seat 4b, 5b of the first pivot member 4 is placed at the position between the spring seat 4b, 5b of the second pivot member 5 and the portion opposing to the spring seat 4b, 5b of the second pivot member 5. The biasing member (the coil spring 8) is placed between the pair of spring seats 4b, 5b.

When the first and second spring seats 4b, 5b are biased to be away from each other, the first and second protruding portions 42a, 52a of the first and second pivot members 4, 5 are displaced in a direction to come close to each other. Accordingly, the first and second protruding portions 42a, 52a of the first and second pivot members 4, 5 come in contact with and come to frictionally engage with the shaft portion 1a.

According to the aforementioned embodiment, the cantilevered spring seat 4b, 5b of each of the first pivot member 4 and the second pivot member 5 is formed in the L-shape. The cantilevered spring seats 4b, 5b of the first pivot member 4 is rotationally symmetrically placed with the cantilevered spring seats 4b, 5b of the second pivot member 5. The biasing member (the coil spring 8) is made from a coil spring 8 and is placed between the pair of spring seats 4b, 5b.

When the first and second spring seats 4b, 5b are biased to be away from each other, the first and second protruding portions 42a, 52a of the first and second pivot members 4, 5 are displaced in a direction to come close to each other. Accordingly, the first and second protruding portions 42a, 52a of the first and second pivot members 4, 5 come in contact with and come to frictionally engage with the shaft portion 1a.

According to the aforementioned embodiment, the spring seat 4b, 5b includes the first and second projection 4c, 5c guiding the coil spring (8). The first and second projection 4c, 5c inhibits the first pivot member 4 and the second pivot member (5) from pivotally moving by the predetermined pivot angle or greater.

The first projection 4c (the second projection 5c) serves as the prevention which inhibits the first clutch lever 41 (the second clutch lever 51) from pivotally moving by the predetermined pivot angle or greater by centrifugal force.

According to the aforementioned embodiment, the rotation and stop retention switching apparatus 100 includes the secondary rotary body 7 surrounding the shaft portion 1a at the circumference of the shaft portion 1a. The secondary rotary body 7 is combined with the rotary body 3 so that the first pivot member 4 and the second pivot member 5 are interposed between the secondary rotary body 7 and the rotary body 3. The pivot shaft 10 includes a second end which is supported by the secondary rotary body 7.

According to the aforementioned embodiment, the clutch lever 41, 51 and the anchor portion 42, 52 are individually formed.

As described above, the first and second pivot members 4, 5 are pivotally supported by the stick member 10 which is supported by the rotary body 3 and the secondary rotary body 7, and are displaced in directions toward and away from the shaft portion 1a in accordance with the pivoting movement of the first and second pivot members 4, 5.

Because centrifugal force is applied to the first and second anchor portions 42, 52 of the first and second pivot members 4, 5, the first and second pivot members 4, 5 come to be away from the shaft portion 1a by centrifugal force applied to the first and second anchor portions 42, 52 of the first and second pivot members 4, 5.

According to the aforementioned embodiment, the spindle includes the rotation and stop retention switching apparatus 100 including the body 1 including the shaft portion 1a within which the second output shaft 20 of the drive motor 200 is configured to be disposed by insertion, the body 1 configured to be connected to the drive motor 200, the pivot member (the first and second pivot members 4, 5) being placed at the circumference of the shaft portion 1a so as to surround the shaft portion 1a, the rotary body 3 being placed opposite the body 1 in the axial direction, the pivot shaft 10 including the first end supported by the rotary body 3, the pivot shaft 10 pivotally supporting the pivot member (4, 5), the biasing member (the coil spring 8) being disposed at the pivot member (the first and second pivot members 4, 5) which is placed at the circumference of the shaft portion 1a, the biasing member (the coil spring 8) being supported by the pivot member (the first and second pivot members 4, 5), and the switching member (the cam member 6) configured to be connected to the output shaft 20, the switching member 6 pressing the pivot member (the first and second pivot members 4, 5) in the direction to separate the pivot member (the first and second pivot members 4, 5) from the shaft portion (1a) against biasing force applied by the biasing member (the coil spring 8) in accordance with the rotation of the output shaft 20. The pivot shaft 10 pivotally supports the pivot member (the first and second pivot members 4, 5) at the opposite side of the biasing member (the coil spring 8) relative to the shaft portion 1a so as to interpose the shaft portion 1a between the pivot member (the first and second pivot members 4, 5) and the biasing member (the coil spring 8). The pivot member (the first and second pivot members 4, 5) comes close to and comes in contact with the shaft portion 1a by the biasing force applied by the biasing member (the coil spring 8). The rotary body 3 rotates by rotation force applied by the output shaft 20 by the gap g formed between the pivot member (the first and second pivot members 4, 5) and the shaft portion 1a in a case where the pivot member (the first and second pivot members 4, 5) is pressed by the switching member (the cam member 6) in accordance with the rotation of the output shaft 20. The spindle further includes the drive motor 200, the planetary gear 300 and the screw 400. The drive motor 200, the rotation and stop retention switching apparatus 100, the planetary gear 300 and the screw 400 are connected in the mentioned order.

Being positioned between the switching apparatus 100 and the screw 400, the gear 300 increases the rotary speed of the switching apparatus 100. Accordingly, the first and second anchor portions 42, 52 for generating centrifugal force can be minimized, leading to the downsizing of the switching apparatus 100 per se. Further, when the screw 400 and the rotary body 3 of the switching apparatus 100 are rotated to open and close the door manually, an operator can decrease the manual operating force immediately after starting the rotation because an inputted manual operation force increases in speed via the gear 300 to achieve high speed rotation.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotation and stop retention switching apparatus, comprising:
a body including a shaft portion within which an output shaft of a drive motor is configured to be disposed by insertion, the body configured to be connected to the drive motor;
a pivot member being placed at a circumference of the shaft portion so as to surround the shaft portion;
a rotary body being placed opposite the body in an axial direction;
a pivot shaft including a first end supported by the rotary body, the pivot shaft pivotally supporting the pivot member;
a biasing member being disposed at the pivot member which is placed at the circumference of the shaft portion, the biasing member being supported by the pivot member; and
a switching member configured to be connected to the output shaft, the switching member pressing the pivot member in a direction to separate the pivot member from the shaft portion against a biasing force applied by the biasing member in accordance with a rotation of the output shaft, wherein
the pivot shaft pivotally supports the pivot member at an opposite side of the biasing member relative to the shaft portion so as to interpose the shaft portion between the pivot member and the biasing member;
the pivot member comes close to and comes in contact with the shaft portion by the biasing force applied by the biasing member; and
the rotary body rotates by a rotation force applied by the output shaft by a gap formed between the pivot member and the shaft portion in a case where the pivot member is pressed by the switching member in accordance with the rotation of the output shaft.

2. The rotation and stop retention switching apparatus according to claim 1, wherein
the pivot member includes a first pivot member and a second pivot member serving as a pair, the first pivot member and the second pivot member facing with each other at the circumference of the shaft portion; and
the biasing member is placed between the first pivot member and the second pivot member, the biasing member includes a first end supported by the first pivot member and includes a second end supported by the second pivot member.

3. The rotation and stop retention switching apparatus according to claim 2, wherein:
the switching member includes a cam member; and
the gap is formed between the first pivot member and the shaft portion and the gap is formed between the second pivot member and the shaft portion in a case where the cam member rotates in accordance with a rotation of the output shaft and the cam member presses the first pivot member and the second pivot member to pivotally move the first pivot member and the second pivot member in a direction away from the shaft portion against the biasing force applied by the biasing member.

4. The rotation and stop retention switching apparatus according to claim 2, wherein the first pivot member and the second pivot member are rotationally symmetrically placed with each other.

5. The rotation and stop retention switching apparatus according to claim 2, wherein;
each of the first pivot member and the second pivot member includes a clutch lever and an anchor portion; and
the gap is formed between the first pivot member and the shaft portion and the gap is formed between the second pivot member and the shaft portion in a case where the first pivot member and the second pivot member rotate in accordance with the rotation of the rotary body to pivotally move in the direction away from the shaft portion in accordance with a centrifugal force applied to each of the anchor portions of the first pivot member and the second pivot member.

6. The rotation and stop retention switching apparatus according to claim 2, wherein;
the first pivot member and the second pivot member facing with each other at the circumference of the shaft portion include end portions, respectively, each of the end portions being provided with a spring seat having a cantilever construction;
the spring seat of the first pivot member is placed at a position between the spring seat of the second pivot member and a portion opposing to the spring seat of the second pivot member; and
the biasing member is placed between a pair of spring seats.

7. The rotation and stop retention switching apparatus according to claim 6, wherein:
the spring seat of each of the first pivot member and the second pivot member is formed in an L-shape;
the spring seat of the first pivot member is rotationally symmetrically placed with the spring seat of the second pivot member;
the biasing member is made from a coil spring; and
the coil spring is placed between the pair of spring seats.

8. The rotation and stop retention switching apparatus according to claim 7, wherein the spring seat includes a projection guiding the coil spring, the projection inhibiting the first pivot member and the second pivot member from pivotally moving by a predetermined pivot angle or greater.

9. The rotation and stop retention switching apparatus according to claim 2, further comprising:
a secondary rotary body surrounding the shaft portion at the circumference of the shaft portion, the secondary rotary body being combined with the rotary body so that the first pivot member and the second pivot member are interposed between the secondary rotary body and the rotary body, wherein the pivot shaft includes a second end which is supported by the secondary rotary body.

10. The rotation and stop retention switching apparatus according to claim 5, wherein the clutch lever and the anchor portion are individually formed.

11. A spindle, comprising:
a rotation and stop retention switching apparatus including:
a body including a shaft portion within which an output shaft of a drive motor is configured to be disposed by insertion, the body configured to be connected to the drive motor;
a pivot member being placed at a circumference of the shaft portion so as to surround the shaft portion;
a rotary body being placed opposite the body in an axial direction;
a pivot shaft including a first end supported by the rotary body, the pivot shaft pivotally supporting the pivot member;
a biasing member being disposed at the pivot member which is placed at the circumference of the shaft portion, the biasing member being supported by the pivot member; and
a switching member configured to be connected to the output shaft, the switching member pressing the pivot member in a direction to separate the pivot member from the shaft portion against a biasing force applied by the biasing member in accordance with a rotation of the output shaft, wherein
the pivot shaft pivotally supports the pivot member at an opposite side of the biasing member relative to the shaft portion so as to interpose the shaft portion between the pivot member and the biasing member;
the pivot member comes close to and comes in contact with the shaft portion by the biasing force applied by the biasing member; and
the rotary body rotates by a rotation force applied by the output shaft by a gap formed between the pivot member and the shaft portion in a case where the pivot member is pressed by the switching member in accordance with the rotation of the output shaft (20),
a drive motor;
a planetary gear; and
a screw, wherein
the drive motor, the rotation and stop retention switching apparatus, the planetary gear and the screw are connected in the mentioned order.
